(19) United States
(12) Patent Application Publication
(10) Pub. No.: US 2013/0169512 A1
(43) Pub. Date: Jul. 4, 2013

(54) ELECTRONIC DEVICE AND METHOD FOR SWITCHING BETWEEN FIRST DISPLAY AND SECOND DISPLAY

(71) Applicant: CHEN-CHI YANG, Hsinchu (TW)

(72) Inventor: CHEN-CHI YANG, Hsinchu (TW)

(21) Appl. No.: 13/663,572

(22) Filed: Oct. 30, 2012

(30) Foreign Application Priority Data
Dec. 28, 2011 (TW) 100149366

(51) Int. Cl. G09G 5/00

(52) U.S. Cl. 345/5; 345/4

(57) ABSTRACT

An electronic device includes a first display and a second display. The first display is used for displaying dynamic images; and the second display is used for displaying static images. The first display is capable of being translucent, and the first display is stacked on the second display.

### BACKGROUND

1. Technical Field

The disclosed embodiments relate to an electronic device and a method for switching between a first display and a second display.

2. Description of Related Art

Traditional electronic devices include a single display for displaying visual content. For example, a traditional device may include a liquid crystal display (LCD) or organic light-emitting diode (OLED) display for displaying color visual content. In another example, a traditional device may include an electronic paper display for displaying black-and-white visual content using minimal power. The type of display included in a traditional electronic device is typically based on an assumption about the visual content it will most often display because different types of displays may be optimal, in performance or efficiency, for different types of visual content. For example, an LCD or OLED display may be optimal for high-resolution or dynamic color content while an electronic paper display may be optimal for relatively static black-and-white content.

However, a traditional device may display multiple types of visual content even though its display may only be optimal for a single type of visual content.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout nine views.

FIG. 1 is a block diagram of an electronic device in accordance with an embodiment, the electronic device includes a first display and a second display.

FIG. 2A is a schematic diagram showing an arrangement of the first display and the second display of FIG. 1 in accordance with a first embodiment.

FIG. 2B is a schematic diagram showing an arrangement of the first display and the second display of FIG. 1 in accordance with a second embodiment.

FIG. 3A is a schematic diagram showing a detailed structure of the first display of FIG. 1 in accordance with a first embodiment.

FIG. 3B is a schematic diagram showing a detailed structure of the first display of FIG. 1 in accordance with a second embodiment.

FIG. 3C is a schematic diagram showing a detailed structure of the first display of FIG. 1 in accordance with a third embodiment.

FIG. 3D is a schematic diagram showing a detailed structure of the first display of FIG. 1 in accordance with a fourth embodiment.

FIG. 3E is a schematic diagram showing a detailed structure of the first display of FIG. 1 in accordance with a fifth embodiment.

FIG. 4 is a flowchart showing a method for switching between a first display and a second display in accordance with an embodiment.

### DETAILED DESCRIPTION

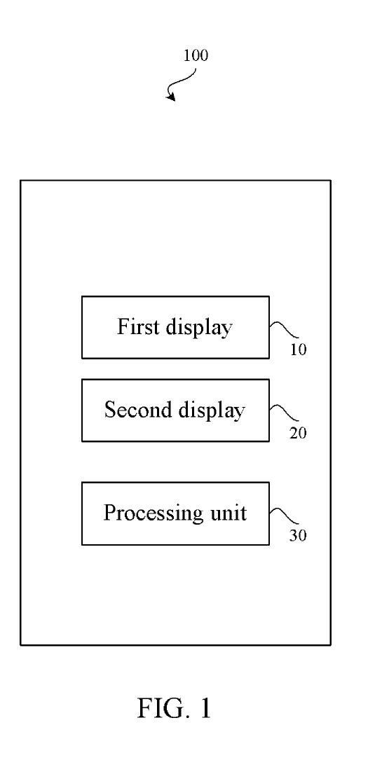

Referring to FIG. 1, an electronic device 100 includes a first display 10, a second display 20, and a processing unit 30. The first display 10 is used for displaying dynamic images, and the second display 20 is used for displaying static images. In this embodiment, the first display 10 is an organic light emitting diode (OLED) display, and the second display 20 is an electronic paper display.

The processing unit 30 determines at least one feature of the visual content, and selectively enables at least one of the first display 10 and the second display 20, based on the at least one determined feature, to display the visual content.

The first display 10 is stacked on the second display 20. When the second display 20 is enabled to display the visual content, the first display 10 is translucent. In a first embodiment, the at least one feature of the visual content includes a rate of change of the visual content, the processing unit 30 enables the first display 10 to display the visual content if the rate of change is above a threshold; and enables the second display 20 to display the visual content if the rate of change is below the threshold.

In a second embodiment, the at least one feature of the visual content includes a color composition of the visual content, the processing unit 30 enables the first display 10 to display the visual content if the color composition is above a threshold; and enables the second display 20 to display the visual content if the color composition is below the threshold.

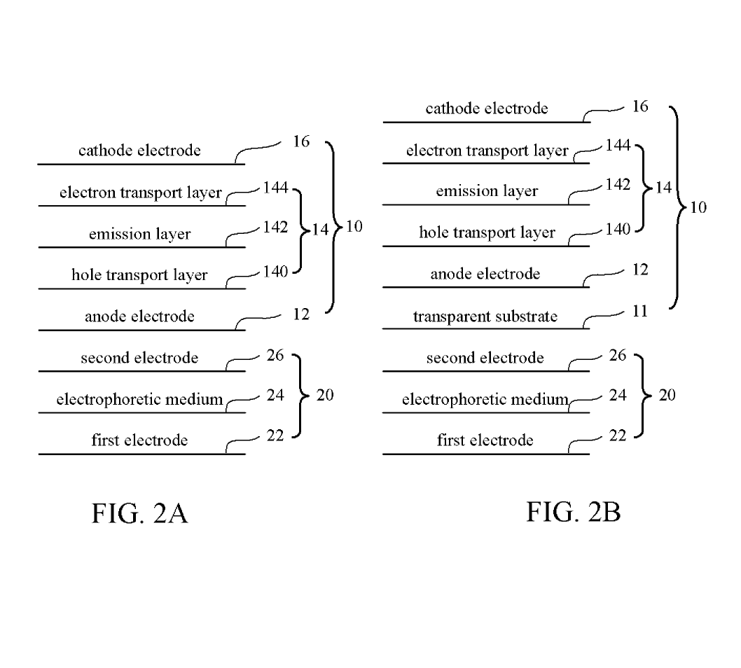

Referring to FIG. 2A, an arrangement of the first display 10 and the second display 20 in accordance with a first embodiment is illustrated. The second display 20 includes a first electrode 22, an electrophoretic medium 24, and a second electrode 26; the electrophoretic medium 24 is located between the first electrode 22 and the second electrode 26. The first display 10 includes an anode electrode 12, an organic region 14, and a cathode electrode 16; the organic region 14 is located between the anode electrode 12 and the cathode electrode 16.

Electroluminescence takes place in the organic region 14 if a voltage is applied between the anode electrode 12 and the cathode electrode 16. The anode electrode 12 of the first display 10 is stacked on the second electrode 26 of the second display 20. In this embodiment, the organic region 14 includes a hole transport layer 140, an emission layer 142, and an electron transport layer 144. Each of the second electrode 26, the anode electrode 12, and the cathode electrode 16 is a transparent electrode.

Referring to FIG. 2B, an arrangement of the first display 10 and the second display 20 in accordance with a second embodiment is illustrated. The second display 20 includes a first electrode 22, an electrophoretic medium 24, and a second electrode 26; the electrophoretic medium 24 is located between the first electrode 22 and the second electrode 26. The first display 10 includes a transparent substrate 11, an anode electrode 12, an organic region 14, and a cathode electrode 16; the organic region 14 is located between the anode electrode 12 and the cathode electrode 16. Electroluminescence takes place in the organic region 14 if a voltage is applied between the anode electrode 12 and the cathode electrode 16. The transparent substrate 11 is stacked on the second electrode 26 of the second display 20, and the anode electrode 12 is stacked on the transparent substrate 11. In this embodiment, the organic region 14 includes a hole transport layer 140, an emission layer 142, and an electron transport layer 144. Each of the second electrode 26, the anode electrode 12, and the cathode electrode 16 is a transparent electrode.

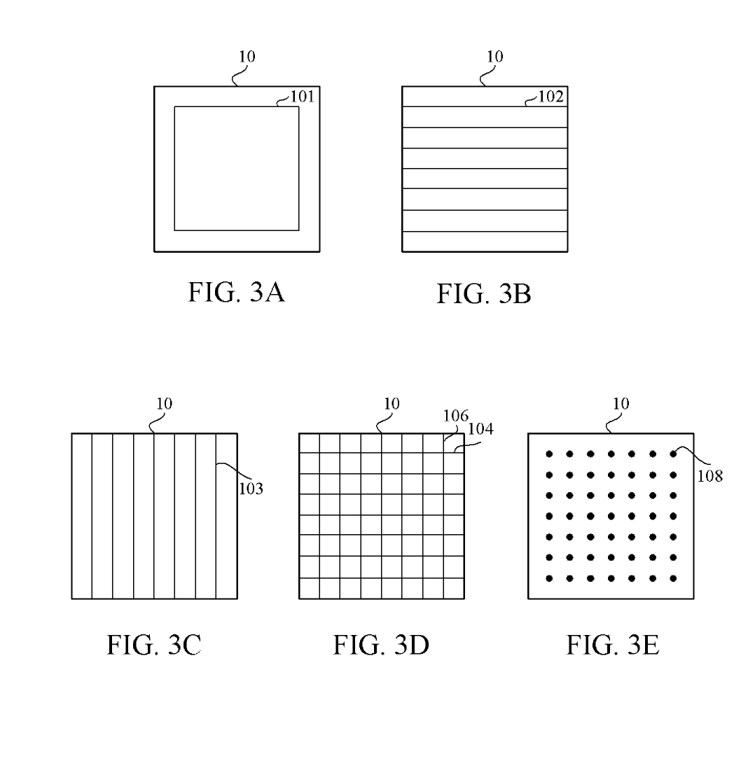

Referring to FIG. 3A, the first display 10 in accordance with a first embodiment further includes a square emission element 101. When the second display 20 displays the visual content, the first display 10 is translucent, and the square emission element 101 is used for emitting light to illuminate the second display 20.

Referring to FIG. 3B, the first display 10 in accordance with a second embodiment further includes a plurality of horizontal emission elements 102 separated from each other. When the second display 20 displays the visual content, the first display 10 is translucent, and the horizontal emission elements 102 are used for emitting light to illuminate the second display 20.

Referring to FIG. 3C, the first display 10 in accordance with a third embodiment further includes a plurality of vertical emission elements 103 separated from each other. When the second display 20 displays the visual content, the first display 10 is translucent, and the vertical emission elements 103 are used for emitting light to illuminate the second display 20.

Referring to FIG. 3D, the first display 10 in accordance with a fourth embodiment further includes a plurality of horizontal emission elements 104 and a plurality of vertical emission elements 106 intersecting with the horizontal emission elements 104, the horizontal emission elements 104 are separated from each other, the vertical emission elements 106 are separated from each other. When the second display 20 displays the visual content, the first display 10 is translucent, the horizontal emission elements 104 and the vertical emission elements 106 are used for emitting light to illuminate the second display 20.

Referring to FIG. 3E, the first display 10 in accordance with a fifth embodiment further includes a plurality of emission points 108. When the second display 20 displays the visual content, the first display 10 is translucent, and the emission points 108 are used for emitting light to illuminate the second display 20.

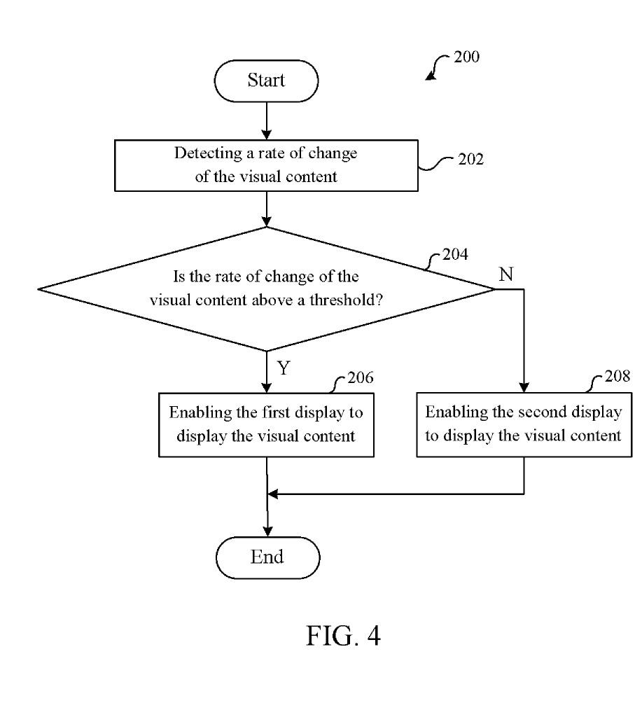

FIG. 4, illustrates a method 200 for switching between the first display 10 and the second display 20 in accordance with an embodiment, the first display 10 is stacked on the second display 20 and overlaps the second display 20. In this embodiment, the first display 10 is an organic light emitting diode (OLED) display, and the second display 20 is an electronic paper display. The electronic device 100 implements the method 200, the method 200 includes the following steps.

Step 202, the processing unit 40 detects a rate of change of the visual content.

Step 204, the processing unit 40 further determines whether the rate of change of the visual content is above a threshold; if the processing unit 40 determines that the rate of change of the visual content is above a threshold, the process goes to step 206; if the processing unit 40 determines that the rate of change of the visual content is below the threshold, the process goes to step 208.

Step 206, the processing unit 40 controls the first display 10 to display the visual content.

Step 208, the processing unit 40 controls the second display 20 to display the visual content. In this embodiment, the processing unit 40 further controls the first display 10 to be translucent when the second display 20 is enabled to display the visual content, for example, the processing unit 40 does not provide video signals to the first display 10, so that the first display (OLED display) 10 is translucent.

In other embodiments, the processing unit 40 detects a color composition of the visual content, therefore step 206 is replaced by the step of controlling the first display 10 to display the visual content if the color composition is above a threshold; and step 208 is replaced by the step of controlling the second display 20 to display the visual content if the color composition is below the threshold.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electronic device, comprising:
a first display for displaying dynamic images; and
a second display for displaying static images;
wherein the first display is capable of being translucent, and the first display is stacked on the second display.

2. The electronic device of claim 1, further comprising:
a processing unit; wherein the processing unit is operative to:
determine at least one feature of visual content; and
selectively enable at least one of the first display and the second display, based on the at least one determined feature, to display the visual content.

3. The electronic device of claim 2, wherein the at least one feature of the visual content comprises a rate of change of the visual content, and the processing unit is operative to:
enable the first display to display the visual content when the rate of change is above a threshold; and
enable the second display to display the visual content when the rate of change is below the threshold.

4. The electronic device of claim 2, wherein the at least one feature of the visual content comprises a color composition of the visual content, and the processing unit is operative to:
enable the first display to display the visual content when the color composition is above a threshold; and
enable the second display to display the visual content when the color composition is below the threshold.

5. The electronic device of claim 1, wherein the first display is an organic light emitting diode (OLED) display, and the second display is an electronic paper display.

6. The electronic device of claim 5, wherein the second display comprises a first electrode, a second electrode, and an electrophoretic medium located between the first electrode and the second electrode; the first display comprises a transparent substrate, an anode electrode, a cathode electrode, and an organic region in which electroluminescence takes place when a voltage is applied between the anode electrode and the cathode electrode, the organic region is located between the anode electrode and the cathode electrode; the anode electrode is stacked on the transparent substrate, the transparent substrate is stacked on the second electrode of the second display; each of the second electrode, the anode electrode, and the cathode electrode comprises a transparent electrode.

7. The electronic device of claim 5, wherein the second display comprises a first electrode, a second electrode, and an electrophoretic medium located between the first electrode and the second electrode; the first display comprises an anode electrode, a cathode electrode, and an organic region in which electroluminescence takes place when a voltage is applied between the anode electrode and the cathode electrode; the organic region is located between the anode electrode and the cathode electrode; the anode electrode is stacked on the second electrode of the second display; each of the second electrode, the anode electrode, and the cathode electrode comprises transparent electrode.

8. The electronic device of claim 7, wherein the organic region comprises a hole transport layer, an emission layer, and an electron transport layer.

9. The electronic device of claim 1, wherein the second display is an electronic paper display, when the second display is enabled to display the visual content, the first display is translucent and is used as an external light source for illuminating the second display.

10. The electronic device of claim 9, wherein the first display comprises a square emission element, the square emission element is used for emitting light to illuminate the second display.

11. The electronic device of claim 9, wherein the first display comprises a plurality of horizontal emission elements separated from each other, the horizontal emission elements are used for emitting light to illuminate the second display.

12. The electronic device of claim 9, wherein the first display comprises a plurality of vertical emission elements separated from each other, the vertical emission elements are used for emitting light to illuminate the second display.

13. The electronic device of claim 9, wherein the first display comprises a plurality of horizontal emission elements and a plurality of vertical emission elements intersecting with the horizontal emission elements, the horizontal emission elements are separated from each other, the vertical emission elements are separated from each other, the horizontal emission elements and the vertical emission elements are used for emitting light to illuminate the second display.

14. The electronic device of claim 9, wherein the first display comprises a plurality of emission points, the emission points are used for emitting light to illuminate the second display.

15. A method for switching between a first display and a second display, the first display used for displaying dynamic images, the second display used for displaying static images;
the first display being stacked on the second display, the method comprising the steps of:
determining at least one feature of the visual content; and
selectively enabling at least one of the first display and the second display, based on the at least one determined feature, to display the visual content;
wherein the first display is capable of being translucent.

16. The method of claim 15, wherein the at least one feature of the visual content comprises a rate of change of the visual content, the step of “selectively enabling at least one of the first display and the second display” comprises the sub-steps of:
enabling the first display to display the visual content when the rate of change is above a threshold; and
enabling the second display to display the visual content when the rate of change is below the threshold.

17. The method of claim 15, wherein the at least one feature of the visual content comprises a color composition of the visual content, the step of “selectively enabling at least one of the first display and the second display” comprises the sub-steps of:
enabling the first display to display the visual content when the color composition is above a threshold; and
enabling the second display to display the visual content when the color composition is below the threshold.

18. The method of claim 15, wherein the second display is an electronic paper display, when the second display is enabled to display the visual content, the first display is translucent and is used as an external light source for illuminating the second display.

19. An electronic device, comprising:
a first display as a translucent display;
a second display stacked on the first display; and
a processing unit receiving a visual content and determining at least one feature of visual content, and further selecting one of the first display and the second display to display the visual content according to the at least one feature of visual content;
wherein when the processing unit selects the second display to display the visual content, the visual content is displayed by the second display and is viewed via the first display.
